(19) United States
(12) Patent Application Publication
(10) Pub. No.: US 2024/0095222 A1
(43) Pub. Date: Mar. 21, 2024

(54) INDIVIDUAL ENTITY LIFE RECORD ENGINE AND SYSTEM

(71) Applicants: RALPH A. KORPMAN, NASHVILLE, TN (US); CINDY A. POST, WINDERMERE, FL (US); W. RANDALL CLEGG, WINTER GARDEN, FL (US); DAVID WRIGHT, HIGHLAND, CA (US)

(72) Inventors: RALPH A. KORPMAN, NASHVILLE, TN (US); CINDY A. POST, WINDERMERE, FL (US); W. RANDALL CLEGG, WINTER GARDEN, FL (US); DAVID WRIGHT, HIGHLAND, CA (US)

(21) Appl. No.: 18/371,396

(22) Filed: Sep. 21, 2023

Related U.S. Application Data
(60) Provisional application No. 63/539,574, filed on Sep. 20, 2023.
(60) Provisional application No. 63/408,501, filed on Sep. 21, 2022.

(51) Int. Cl. G06F 16/21; G06F 16/2457

(52) U.S. Cl. CPC G06F 16/211; G06F 16/24575

(57) ABSTRACT

A system, apparatus, and related methods for the collection, standardization, evaluation, and processing of entity life and care information from diverse information systems and sources. After collection, the life and/or care data and information contained in a particular message is transformed, which includes being standardized, processed, evaluated, and converted, into a Curated Manifest (CM), a persisted and immutable document compatible with the particular configuration and design of the ILR platform/system in a specific context. The CM is stored in one or more databases, along with a multiplicity of other CMs. Contextual Best Record (CBR) views, which may be standard, pre-established views or views constructed “on-the-fly” or “on demand”, are used to find, locate, identify and report responsive data from the stored CMs.

This application claims priority to and benefit of U.S. Provisional Application No. 63/408,501, filed Sep. 21, 2022, and U.S. Provisional Application No. 63/539,574, filed Sep. 20, 2023, both of which are incorporated herein in their entireties by specific reference for all purposes.

### FIELD OF INVENTION

This invention relates to an apparatus and system for the collection, standardization, evaluation, and processing of information about an entity, including the creation of multiple curated entity life record components, which are then accessible to a variety of contextual best record views.

### SUMMARY OF INVENTION

In various exemplary embodiments, the present invention comprises a system, apparatus, and related methods for the collection, standardization, evaluation, and processing of entity life and care information from diverse information systems and sources. An “entity” is an object, item, person, or something being cared for, collected, maintained, or the like. An entity may be an animate or inanimate object. In several embodiments, an entity has a high value (such as, but not limited to, financial, emotional, historical, or other form of value), and as such, lives or is maintained or retained for a substantial or long period of time, thus needs to be monitored and documented during its lifecycle or during the period of maintenance or retention. Examples of “entities” include, but are not limited to, animals (e.g., dog, cat, horse, giraffe, and the like), individuals/humans (e.g., family members, service personnel, members, consumers, patients, clinicians, service providers, subscribers, users, and the like), vehicles (e.g., automobiles, motor vehicles, buses, trucks, vans, scooters, planes, trains, bulldozers, excavators, construction vehicles, and the like), items or objects (e.g., books, art pieces, antiquities, manuscripts, furniture, crystal, coins, jewels, guns, and the like), equipment/5 machinery (e.g., robots, manufacturing equipment, field analyzers, computers, mobile computing devices, laptops, computer network servers and components, and the like), properties (e.g., real estate parcels, buildings, houses, bridges, roadways, and the like), organizations (e.g., employers, governmental entity or agency, business entities, payors, service providers, hospitals, labs, reference laboratories, imaging centers, nursing homes, and the like), and other forms of vital or valuable business or personal items or entities.

In several exemplary embodiments, the present invention comprises an Individual Entity Life Record (ILR) platform or system that uses its “connectivity” function to receive or actively mine a plurality of entity information streams and other data sources for messages containing information about an entity or a plurality of entities, said information including, but not limited to, care data. The entity or entities may be known in advance, or the data may be analyzed to identify an entity or entities. Data may also be obtained by direct entry of data by an entity care specialist in cases where the entity has been previously identified, and in some cases, along with particular entity information elements, as discussed in more detail below.

After collection, the life and/or care data and information contained in a particular message is transformed, which includes being standardized, processed, evaluated, and converted, into a Curated Manifest (CM), a persisted and immutable document compatible with the particular configuration and design of the ILR platform/system in a specific context. The CM is stored in one or more databases, along with a multiplicity of other CMs. A CM is not limited to the history of an entity, but may include all types of activities and events that an entity experiences or has experienced.

Contextual Best Record (CBR) views, which may be standard, pre-established views or views constructed “on-the-fly” or “on demand”, are used to find, locate, identify and report responsive data from the stored CMs. A rules engine may apply rules to modify and/or enhance the data and CBR views. The application of rules may, in turn, create data and information, which then is stored as a separate or new CM. The data externalization function manages the interaction with external users and inquiries, including providing API responses.

### BRIEF DESCRIPTION OF THE DRAWINGS

FIG. 1 shows a diagram of general relationships between major functions of the present invention.

FIG. 2 shows a diagram of an ILR system architecture with various application services.

FIG. 3 shows the system architecture of FIG. 2 but with three cooperating monoliths.

FIG. 4 shows an example of scaling services with multiple process threads.

FIG. 5 shows a diagram of the transformation of a payload into an ILR-structured Curated Manifest.

FIG. 6 shows the basic structure of a Curated Manifest.

FIG. 7 shows a diagram detailing the data curation process.

FIG. 8 shows the use of Observables and Observations in the creation of a Curated Manifest and representation of data in a CBR View.

FIG. 9 shows an example of a CBR View index.

FIG. 10 shows the relationship of multiple CBR Views based upon select data from Curated Manifests.

FIG. 11 shows a diagram of the Interactive API Service in relation to external applications and related ILR data processes.

FIG. 12 shows the use of credentials by the Interactive API Service of FIG. 11.

### DETAILED DESCRIPTION OF EXEMPLARY EMBODIMENTS

In various exemplary embodiments, the present invention comprises a system, apparatus, and related methods for the collection, standardization, evaluation, and processing of entity life and care information from diverse information systems and sources. An “entity” is an object, item, person, or something being cared for, collected, maintained, or the like. An entity may be an animate or inanimate object. In several embodiments, an entity has a high value (such as, but not limited to, financial, emotional, historical, or other form of value), and as such, lives or is maintained or retained for a substantial or long period of time, thus needs to be monitored and documented during its lifecycle or during the period of maintenance or retention. Examples of “entities” include, but are not limited to, animals (e.g., dog, cat, horse, giraffe, and the like), individuals/humans (e.g., family members, service personnel, members, consumers, patients, clinicians, service providers, subscribers, users, and the like), vehicles (e.g., automobiles, motor vehicles, buses, trucks, vans, scooters, planes, trains, bulldozers, excavators, construction vehicles, and the like), items or objects (e.g., books, art pieces, antiquities, manuscripts, furniture, crystal, coins, jewels, guns, and the like), equipment/machinery (e.g., robots, manufacturing equipment, field analyzers, computers, mobile computing devices, laptops, computer network servers and components, and the like), properties (e.g., real estate parcels, buildings, houses, bridges, roadways, and the like), organizations (e.g., employers, governmental entity or agency, business entities, payors, service providers, hospitals, labs, reference laboratories, imaging centers, nursing homes, and the like), and other forms of vital or valuable business or personal items or entities.

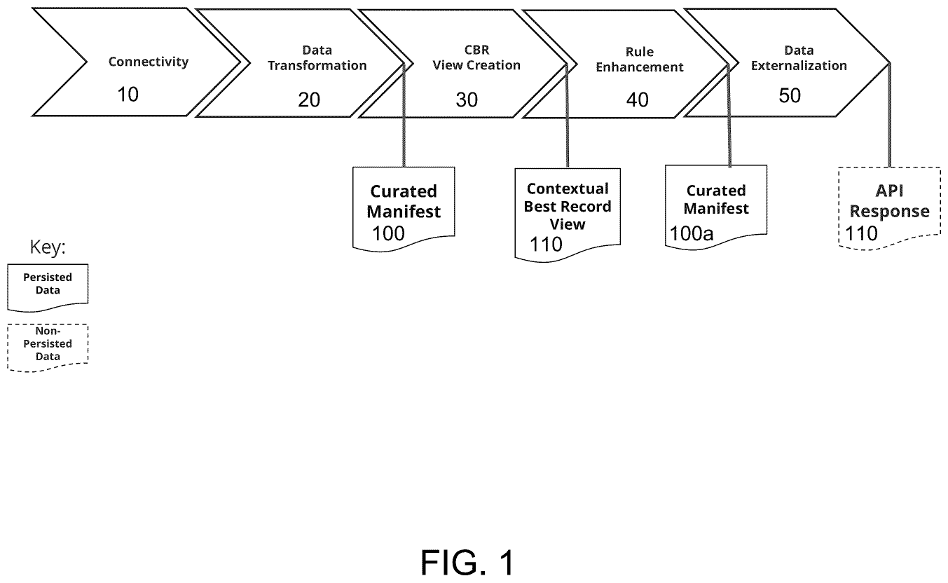

FIG. 1 shows general relationships between major functions of the present invention. In general, the present invention comprises an Individual Entity Life Record (ILR) platform or system that uses its “connectivity” function 10 to receive or actively mine a plurality of entity information streams and other data sources 8 for messages containing information about an entity or a plurality of entities, said information including, but not limited to, care data. The system may receive this data over one or more telecommunications or similar networks, wired or wireless, including, but not limited to, the Internet, the World Wide Web, or the “Cloud.” The entity or entities may be known in advance, or the data may be analyzed to identify an entity or entities. Data may also be obtained by direct entry of data by an entity care specialist in cases where the entity has been previously identified, and in some cases, along with particular entity information elements, as discussed in more detail below.

After collection, the life and/or care data and information contained in a particular message is transformed 20, which includes being standardized, processed, evaluated, and converted, into a Curated Manifest (CM) 100, a persisted and immutable document compatible with the particular configuration and design of the ILR platform/system in a specific context. The CM is stored in one or more databases, along with a multiplicity of other CMs. A CM is not limited to the history of an entity, but may include all types of activities and events that an entity experiences or has experienced.

Contextual Best Record (CBR) views 110, which may be standard, pre-established views or views constructed “on-the-fly” or “on demand” 30, are used to find, locate, identify and report responsive data from the stored CMs. A rules engine may apply rules 40 to modify and/or enhance the data and CBR views. The application of rules may, in turn, create data and information, which then is stored as a separate or new CM 100a. The data externalization function 50 manages the interaction with external users and inquiries, including providing API responses 120.

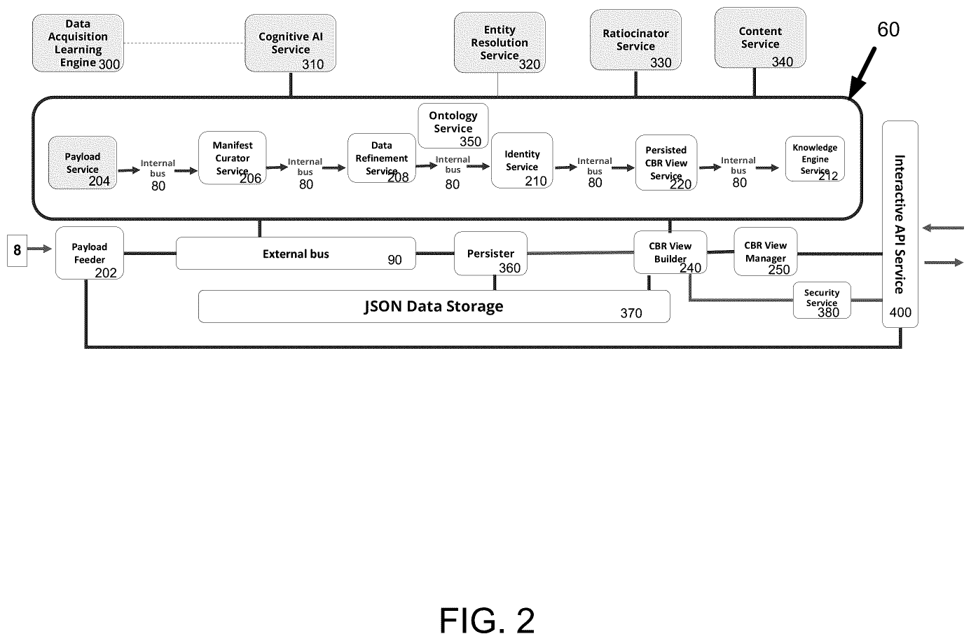

FIG. 2 shows a general diagram of an ILR system architecture identifying various service and related components used to perform the five basic functions described above to create and maintain an ILR (i.e., an individual entity life record). It should be noted that the ILR for an individual entity is not a single object (such as in an object-oriented program), or a single record (such as in a database). Instead, data is stored in ILR-prescribed data structures in the multiple immutable and persisted CMs, which is then used to inform and provide a variety of CBR views, as described in more detail herein.

The components shown in FIG. 2 include, but are not necessarily limited to, a data acquisition learning engine (DALE) 300, a Cognitive AI Service 310, an Entity Resolution Service 320, a Ratiocinator Service 330, a Content Service 340, an Ontology Service 350, a Persister 360, JSON Data Storage 370, Security Service 380, a payload feeder 202, a Payload Service 204, a Manifest Curator Service 206, a Data Refinement Service 208, an Identity Service 210, a Knowledge Engine Service 212, a Persisted CBR View Service 220, a CBR View Builder 230, a CBR View Manager 240, and an Interactive API Service 400. Communications are handled through a combination of internal buses 80 and external buses 90.

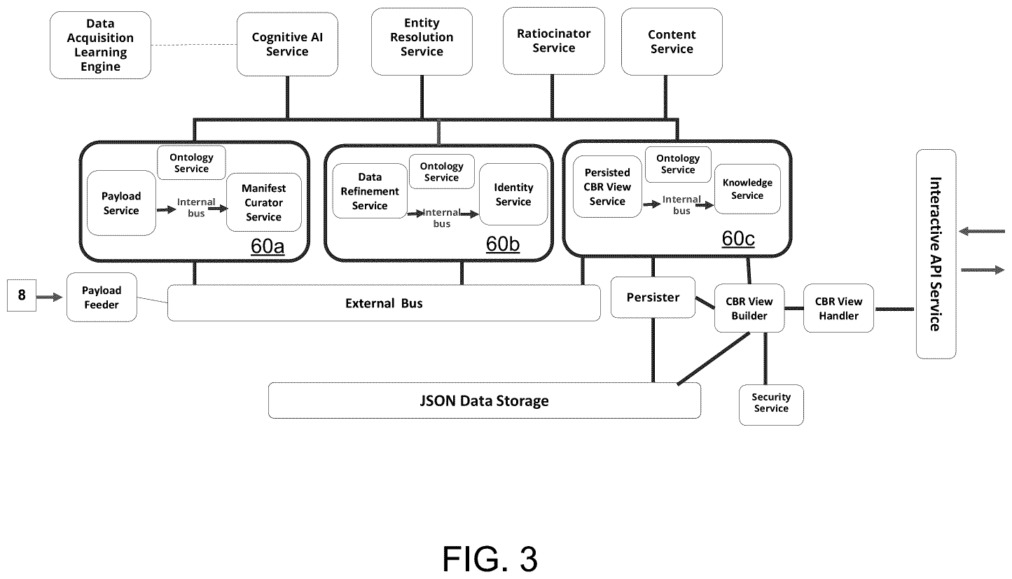

As the hardware and related resources available for a particular installation of the ILR platform can vary greatly, certain individual processes and components of the ILR system can be organized by assignment to “cooperating monoliths” to take appropriate advantage of those available resources for greater speed and effectiveness, depending on the needs and context of each particular installation. In general, a monolith is a set of sets of threads, each set of which coordinates to perform one of the major processing tasks, the various groups communicating with each via internal memory-based queues. Thus, for example, FIG. 2 shows six services (payload service, manifest curator service, data refinement service, identity service, persisted CBR view service, and knowledge engine service), together with the ontology service, in a single monolith 60. All of these services are able to communicate quickly through an internal bus 80. In an alternative configuration, as seen in FIG. 3, these services re divided into three cooperating monoliths 60a-c. The ontology service is provided in each, as it is used by each of the other services. The persister service likewise provided in each in this diagram. The services may be organized in other combinations in multiple monoliths, depending on the needs and context of the particular installation.

The services in each monolith communicate internally through a corresponding internal bus, but communicate with the services in other monoliths through the external bus (which is generally slower). Internal buses provide fast queuing and communications between the ILR services in the corresponding monolith. The services and related processes look at the internal bus for CMs coming for the preceding process/service. The external bus (or buses) provides infrastructure that allows the different processes/services to work together in a decoupled manner, primarily concerning processes/services interacting with CMs, input payloads, and/or external API processes and communications. The external bus also provides communications between monoliths and also with the payload feeder. The use of a shared message bus provides the widest bandwidth to get processes/services working concurrently.

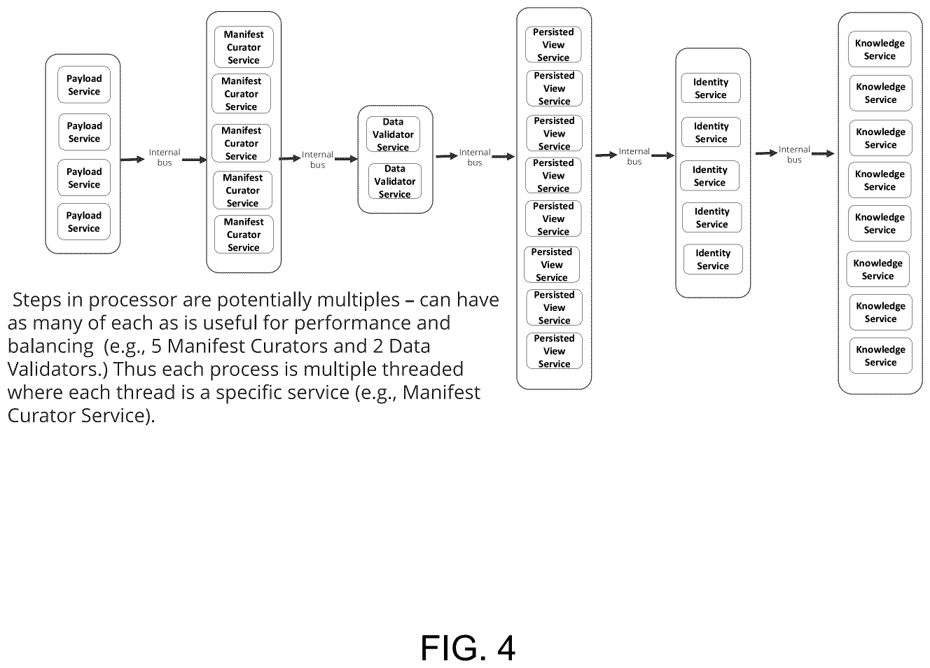

The ILR system architecture design can be scaled for high performance (horizontal scaling, as described above, as well as scaling based on the end user/customer infrastructure and objective). An example of scaling with multiple process threads is shown in FIG. 4. Steps in the processor (or processors) are potentially multiples, i.e., the system can have as many of each service running as is useful for system performance and balancing (e.g., 4 payload services, 5 manifest curator services, 3 data validator services, and so on). Each process is multiple threaded, where each thread is a specific service (e.g., manifest curator service).

The system thus is flexible and adaptable with a layered approach. Maintainability of the system is high due to the uniform system configuration, and it is reliable and provides high availability to data. Failover design (i.e., failover mode or backup operational mode, where standby computing equipment, such as a server, hardware component, and/or network, automatically takes over operations when the main system, or a portion thereof, fails, thereby preventing, eliminating, or reducing an outage in operations and any resulting negative impact) may be based on the end-user/customer infrastructure and objects.

The ILR system receives data input messages of various types from a variety of sources through the payload feeder 202. All data inputs, regardless of type, are referred to herein as “payloads,” and include, but are not limited to, data exchange messages and API requests. The feeder can process messages from a queue or topic. In particular, it can monitor and listen for payloads that are placed in a queue. The system can parse a variety of input message types, including, but not limited to, API, Delimited, HL7 FHIR, HL7v2, HL7 CCD/CDA, NCPDP, and X12.

The payload feeder monitors and manages connectivity runtime components, including a channel-based interface engine. It provides the connections to the sources systems, accepts any inbound message format, provides real-time loading and bulk loading, provides initial message handling (i.e., rules-based filtering and routing, syntax validation, edit checking, and the like), provides message transformation, queuing, forwarding, and storing, provides message journaling, and manages message priority. While payloads can be processed based on time of receipt (e.g., first-in, first-out), in a preferred embodiment, payload processing is priority-based (e.g., normal, high, immediate) based on the source and/or type of payload. For example, API interactions involving an end-user/customer typically would be prioritized as “immediate” priority.

The payload service 204 parses and converts an input payload into a multi-JSON document called a “Payload Manifest Schema (PMS)”. More specifically, it converts an input payload to a series of discrete data key-value pairs matching parsed data from the payload to semantic ontology definitions. These are referred to as “observables.” The processed payload (i.e., PMS) is then sent to the manifest curator service 206 on the internal bus. Note that this transfer (and subsequent related transfers or communications discussed below) are described as if the services involved are in the same monolith, as described above. In cases where a transfer or other communication is between services in different monolith, than the external bus will be involved.

The manifest curator service 206 acquires each PMS from the bus, and processes and transforms the paired observable-data into an ILR multi-JSON semantic normalized representation. Both context and externally-coded data are represented as ontology concepts. Data are grouped according to context based on interpreting their semantic definitions (see the discussion of the Ontology Service below). Related fields are grouped related observations. Related observations are further grouped by the role of the actor which they observe (e.g., a service provider, a patient, a primary care physician, and so on). Related observations further may be grouped by the context of the service and supply product used in performing the service (i.e., an item). The resulting ILR multi-JSON semantic normalized representation is the initial Curated Manifest associated with that payload.

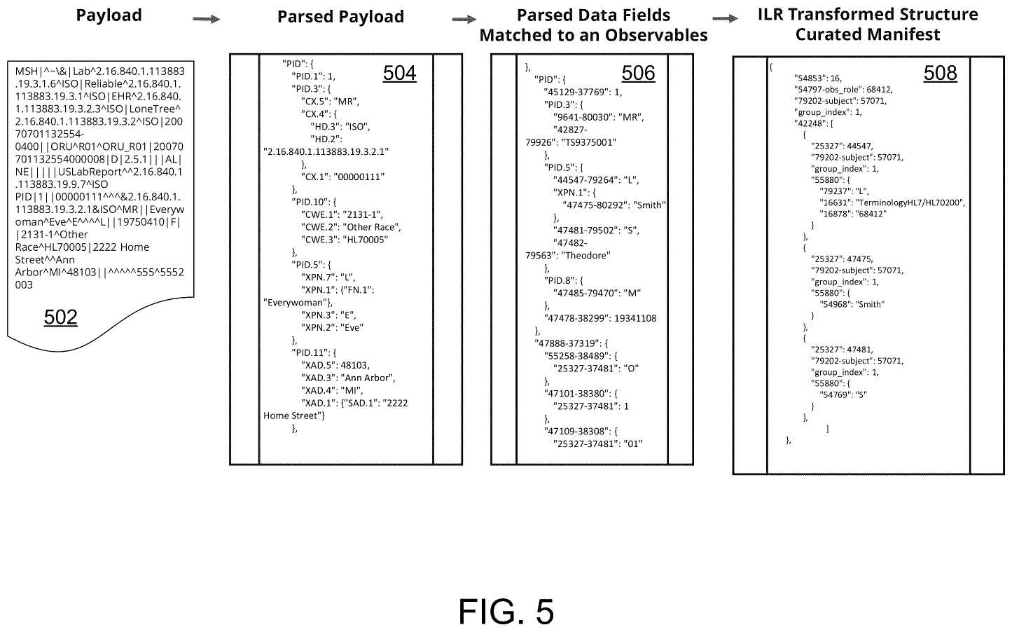

FIG. 5 shows a representative diagram of this transformation of the payload received from the source 502, which is processed to produce a parsed payload 504. Parsed data fields are then matched to observables 506, with subsequent transformation into the ILR-structured Curated Manifest 508.

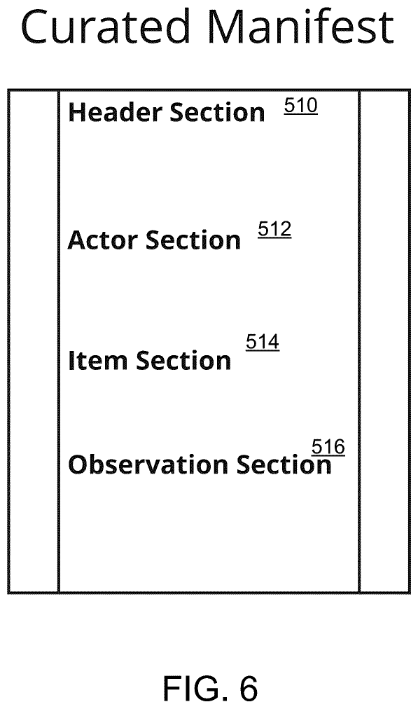

FIG. 6 shows the basic structure of a Curated Manifest, comprising a Header section 510, an Actor section 512, an Item section 514, and an Observation section 516. Each payload received results in the created of a single CM, resulting from multiple processing actions. Only data of interest (i.e., “curated”) are transformed to an ILR representation in the CM. The CM is immutable and persisted.

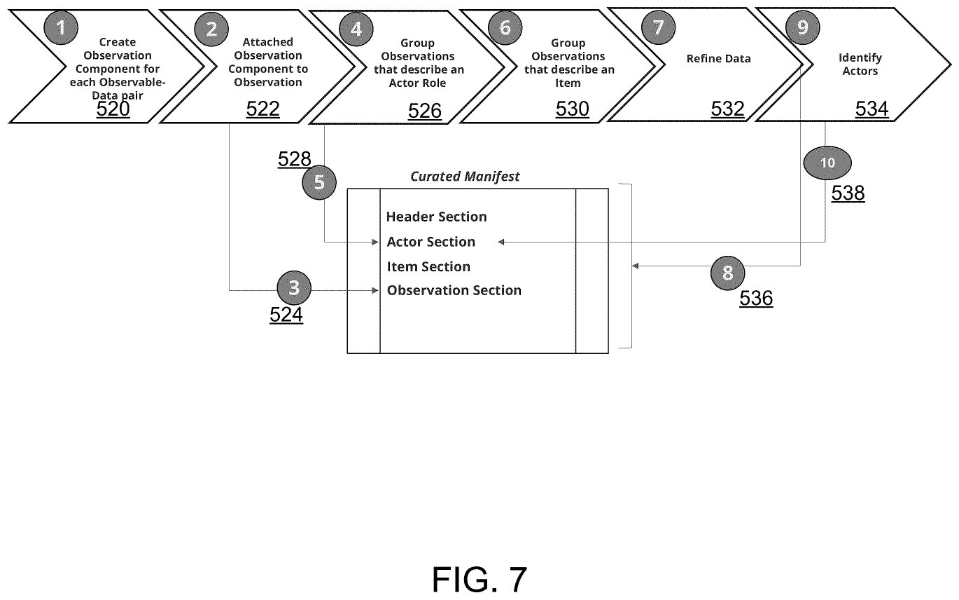

FIG. 7 shows the data curation process to create the CM in more detail. The system creates an observation component for each observable-data pair 520, and attaches the observation component to observation 522, which are then added to the Observation section 524. Next, the system groups observations that describe an actor role 526, may then be added to the Actor section 528. Next, the system groups observations that describe an Item 530. The system then calls on services for data refinement 532 and identification services 534, with items and actor identifications being added to the Item and Actor sections 536, 538. The Header section of the CM contains general data about the source payload, and the identification and creation of the CM itself.

The CM structure is created from an ontology description language defined for the particular application. Each source data field is represented as an observation component. In several embodiments, it comprises a role identified by a key and an ontology concept identifier providing field-specific context. The source data value is represented by another key value pair, where the value attribute property provides the key for the source data value. Observation components are grouped into an observation, providing context based on ontology definition. For example:

Observation—Blood Pressure
Systolic Blood Pressure—120
Diastolic Blood Pressure—90
Blood Pressure Method—doppler
Blood Pressure Patient Position—sitting

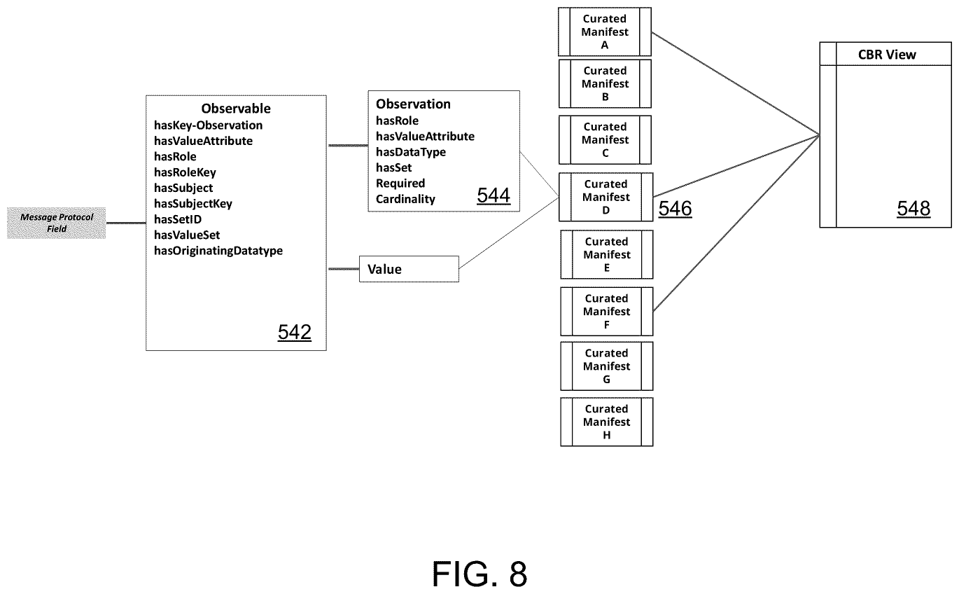

As seen in FIG. 8, the Observable 542 and Observation 544 ontology definitions provide both meaning and context to the data which gets represented in the corresponding CM (e.g., CM “D”) 546. Other CMs created from other payloads may contain related or matching data. As discussed in more detail below, matching data across all CMs are compared to determine the “best” data based on the situation or purpose (i.e., context) for which the data was requested. Data that may be considered the “best” in one context may not be the “best” in another context. The best data for the given context is then represented in a multi-JSON document called a CBR view 548.

The Data Refinement Service 208 manages the sending of CMs during the data transformation process to the Cognitive AI Service 310 to automatically check data integrity and automatically remedy or resolve problems that may have been identified. The Data Refinement Service in turn receives the remediation solutions to the data problems, and places them in the CM. In cases where issues require resolution/remediation beyond the capacity of the Cognitive AI Service, those issues are marked and a notification is generated and sent.

The Cognitive AI Service 310, as indicated in FIG. 2, is generally available to all services. It resolves issues with problem data based on its learned knowledge. It can resolve semantic problems such as not understood data (e.g., UnCIDed), data conversion issues (e.g., the parsing or combining of data values, actor name conversions, address and telephone conversions, timestamp conversions, and value conversions). It also can executes validation logic that checks the quality and consistency of source data, such as non-sensical data (e.g., blood pressure=0; pregnancy for a male; data generation date before a person's birthdate or conception date). This validation logic includes:
Data type validation—compares individual data characters received to expected known primitive data type.
Format data validation—verifies that certain data values meet expected character minimum/maximum ranges, sequences, or consistency patterns.
Missing data validation—identifies missing required data (e.g., missing time zone, missing identifier assigning authority).
Logical data validation—validates that (i) data fields that are consistent with one another, (ii) dates representing activity are appropriate in sequence, and (ii) status correlates with dates.

It also can identify and resolve issues such as unconnected or orphaned data. This service also enhances data beyond what was received, including, but not limited to, deductions, confidence evaluation and/or ratings, event occurrence date determination, provenance, and use of semantic knowledge. It further intensifies, increases, and/or improves the quality, value, and/or extent of data contained in a CM itself, as described above. It also can provide service variants, such as enforcing appropriate CIDs based on characteristic concepts, provide the service has enough context to know what it is looking at.

The ILR system depends on the ability to accurate identify and/or create an entity, and link data correctly through or based on entities. As discussed above, there are many types of entities. The Identity Service 210 detects actors within CMs during the data transformation process that require actor identification. It submits actor knowledge structure (actor-related observations) to the Entity Resolution Service 320, which is responsible for determining and/or obtaining the identity of each entity in a CM. The Entity Resolution Services is rules-based and deterministic, and is data-source specific. It only uses data in a submitted CM, and its focus is on the Actor section. The Entity Resolution Service implements an identity matching process to identify an entity, and returns the resolved actor/entity identification (e.g., an ILR Actor Key that has been assigned to the entity). The Identity Service receives the resolved actor/entity identification, and updates the Actor data in the CM.

The identification process uses criteria-based matching rules. Criteria are data source system specific (i.e., interface specific). One or more criteria can be associated with a data source/interface. There is a library of matching criteria. This allows the criteria to be reused. As best practices are established, they can easily be applied to another data source. Rules support entity type matching (e.g., person vs organization) and role-based matching (e.g., patient vs provider vs supplier). Each rule set contains one or more criteria which must be met to achieve a successful match.

When two entities in the ILR system are later recognized to be the same entity, the system merges them by creating a third entity with its own identification key. Data from the original two entities essentially are merged by linking to the third entity as well. Not only do CMs and payloads point to the original entity, they also point to the new entity. Any new data generated directly by or on the new third entity (i.e., merged entity) will be attached to that entity.

Merged (linked) entities can be separated by unlinking (i.e., “unmerged”). Audit histories are created for each entity involved in the unmerge, and the formerly merged entities can be access via the relevant audit histories. Any CM on the merged entity must be manually assigned to the appropriate one of the original two entities.

The Ontology Service 350 provides optimal interaction between ILR processes/services and the ILR Ontology. Behavioral functions supported include, but are not limited to, ascertaining domain knowledge (including, but not limited to, terminology, relationships, definitions, and defining characteristics) from ILR semantically-encoded data (e.g., CM data), and translating between external terminologies (external terms and definitions) to ILR ontology concepts and semantic expressions. The ILR semantic knowledgebase is a curated formal modal of domain-specific information, and adheres to formal ontologic syntax. It provides fact-based, domain-specific knowledge that underpins the Cognitive AI engine discussed above by serving as a knowledge source for the engine's machine-learning process. The semantic knowledgebase also provides semantic language for representing all data, both keys and codable values. Semantic keys provide data context.

ILR data is semantically encoded. Coded data received in a payload becomes semantically transformed. Data is stored as an ILR concept code (CID) along with a terminology code, code description, and terminology code set.

The Knowledge Engine Service 212, which works with the Ratiocinator Service 330, is a general purpose ILR rule execution platform, and provides execution of semantic-based decision support with the resultant creation of new (i.e., added) data. It is aware of the ILR knowledge structure, and interpretative. It applies rules defined in ILR rules language.

The Persister service 360 looks for messages that are in a state that indicates that they are ready to be stored in the database. It places CMs into the JSON data storage. It can be involved by any of the ILR application services.

The CBR View Builder service 230 is responsible for the creation of new data representations for a given context by aggregating the data contained in curated documents (e.g., CMs) and/or cognified views using the contextual best process to achieve the contextual best view of data using semantic-based operations. The CBR process is triggered by the Persisted CBR View Service 220 or the CBR View Manager 240, and build a best view for an entity based on the requested context (e.g., the context of the request). It takes the related knowledge structures from a filtered set of CMs, and determines the “best” representation based on the requested context. “Best” is determined from contextual criteria. The CBR algorithm is based upon matching data, and/or select multi-criteria parameters, such as, but not limited to, time or time periods, data source (some data sources are better than others for a particular piece of data), data status (status identifies whether data has been amended, corrected, or updated), and knowledge about the condition, product, or procedure (which provides information used to determine better information or to make inferences). For example, it applies an “isBetter” determination when comparing existing data with proposed data (e.g., replacement data), and takes appropriate action. If the proposed data is better, then it takes action A (e.g., update the CBR). If the proposed data is not better, then it takes action B (e.g., do not update the CBR).

The Persisted CBR View Service 220 is responsible for managing the CBR Views that are updated in real-time as CMs are created (i.e., Persisted CBR Views). These are CBR Views that are persisted in the ILR database, providing ready availability for delivery upon data request. Which views are Persisted CBR Views depends on which views are frequently used or critical for the user/customer. Based upon the data requested, if a Persisted or otherwise pre-existing CBR View does not exist, the CBR View builder will create a CBR View on-demand to deliver the requested data.

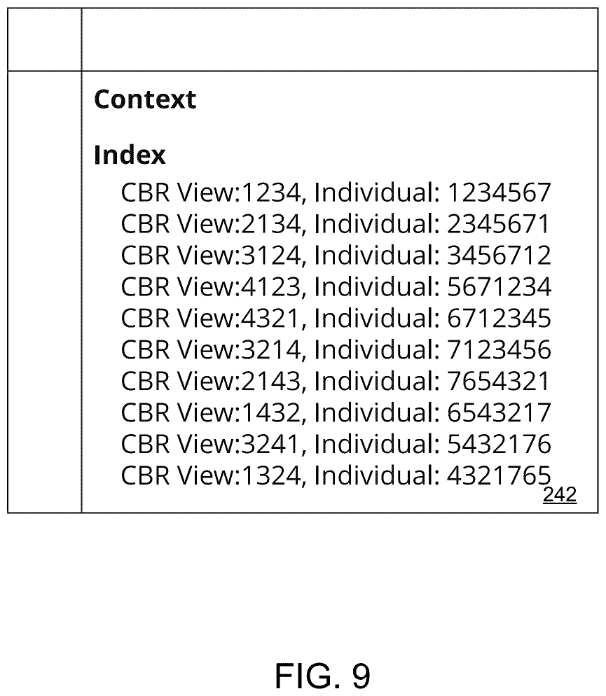

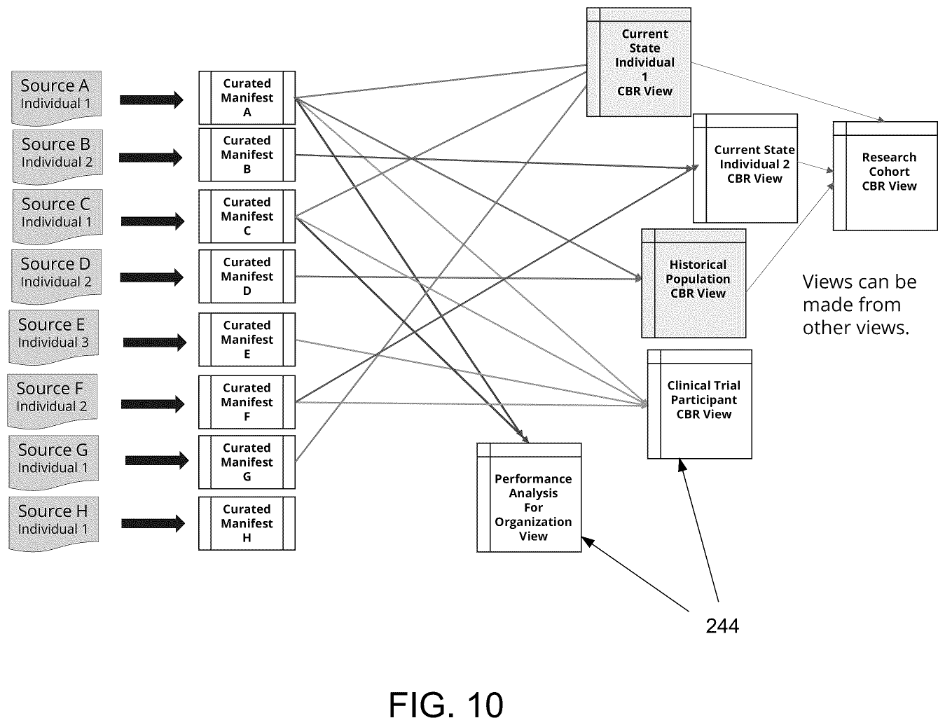

CBR Views may be indexed. FIG. 9 shows an example of a CBR View index 242 in multiple JSON format with pointers to existing individual CBR Views. Indexes may be used to create a CBR View from other CBR Views. The system thus supports multiple cognitive contextual views (i.e., CBR Views) 244 based upon select data from CMs, as seen in FIG. 10.

The system provides data externalization (i.e., it provides selected third parties, such as users, customers, suppliers, business partners and the like) with access to critical resources (e.g., information, applications) to enable more effective operation (e.g., business operations).

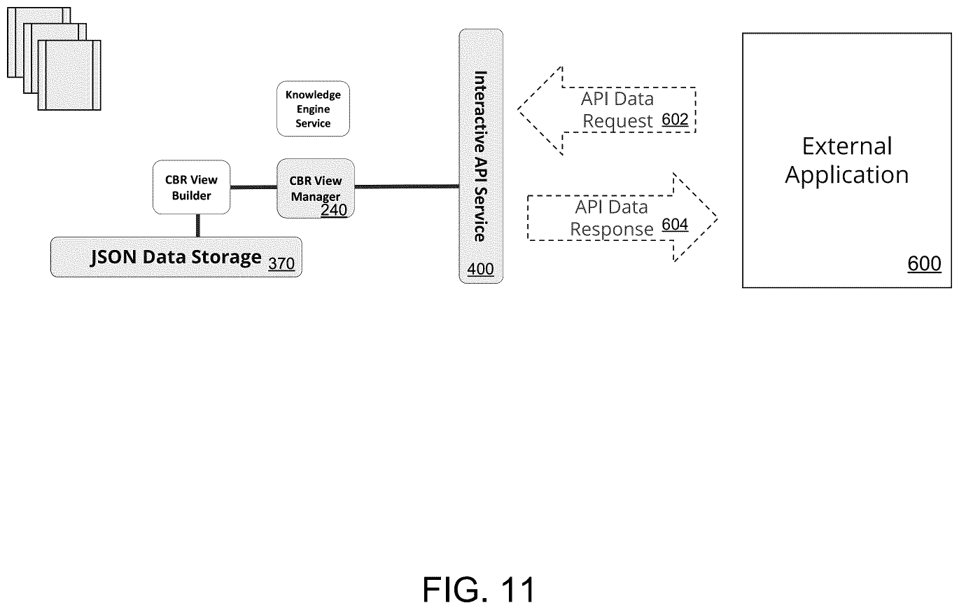

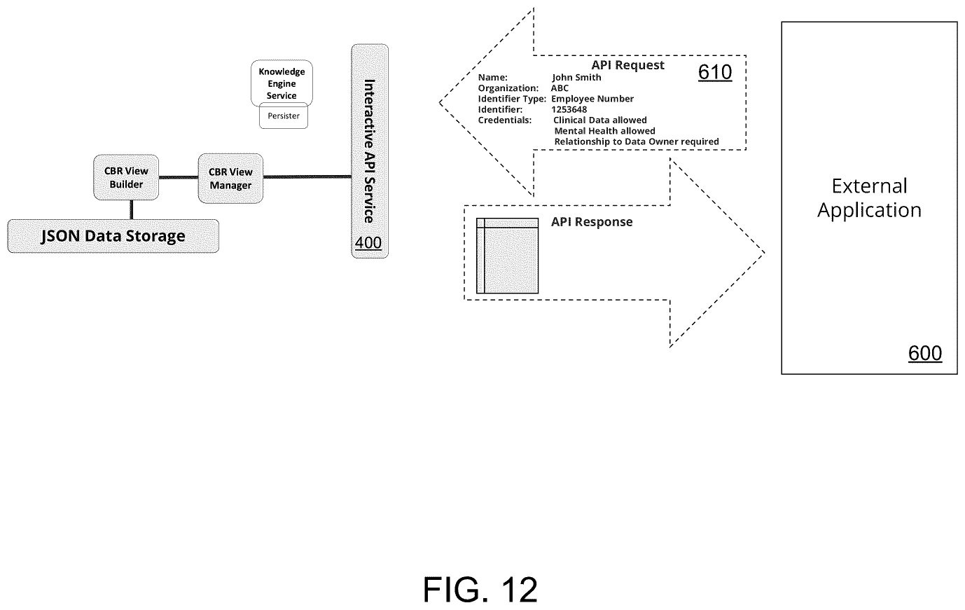

APIs (Application Programming Interfaces) are a standard set of protocols that enable applications to communicate with each to other exchange information. APIs act as the gateway between applications, offering a set of defined rules that allow applications to “talk” to each other and share information. As seen in FIG. 11, the Interactive API Service (iAPI) 400 mediates between users of external web applications 600 and ILR data processes. Management of ILR user authorization (i.e., security) is performed by the iAPI Service based on security best practices to protect data using policies enforced by an API gateway. User authentication may be performed by the external web application or service, with the iAPI providing authorized data based upon the credentials 610 of the user/submitter/data-requestor passed to the iAPI, as seen in FIG. 12. Communications between the external web applications, or users/customers, and the iAPI, or other components of the ILR system, may be over one or more telecommunications or similar networks, wired or wireless, including, but not limited to, the Internet, the World Wide Web, or the “Cloud.”

Authorization rights are based on the credentials of the data requestor, and the system returns only the requested data for which the requestor is authorized. Restrictions can include population restrictions (which limits which ILRs are authorized), operation restrictions (which affect which data actions can be performed, such as adding or access data), and data restrictions (which limit which data can be added or accessed based on class data). With regard to data restrictions, since data is understood by ontological coding, restrictions can be made at any hierarchical level of the ontology. Examples of restricted data include, but are not limited to, financial data, personal identifiers, health data, and/or behavioral/mental health data.

An API Data Request 602 is sent by an external application 600. The iAPI service 400 forwards an appropriate request to the CBR View Manager 240, which translates the data request into a query language understandable to the ILR system. The ILR data responsive to the request is delivered in view form, as described above, or otherwise transformed to the requested format for delivery by the Interactive API Service (e.g., ILR knowledge structure format is transformed to HL7 FHIR format) to the external application 604.

JSON Data Storage 370 is the database where persisted ILR data is stored. It manages the data store by providing mechanisms to synchronize and share data with multiple ILR processes concurrently. Data submitted by the Persister Service is stored here. Data requested by the CBR View Builder service is provided from here.

The system provides internalization/localization support. Timestamps are convertible to a desired locale. Locale-specific actor name variations and/or address variations are supported. The semantic knowledge system supports multiple languages, and ontology concepts terms can be sent in a language or languages associated with a requested locale.

Initial data acquisition is handled by the Data Acquisition Learning Engine (DALE) 300, which implements an integrated machine-learning process to develop a robust interface for data acquisition. The target or goal is to transform inbound messages to ILR-standardized formats, while minimizing transformation work and with rapid implementation. The interface building process comprises the following:
1. Create interface identification.
2. Feed exemplar messages into the system.
3. Use machine learning through DALE to resolve model inconsistencies and exceptions.
4. Run exemplar messages through the learning engine to be examined by DALE.
5. DALE produces a proposed interface definition with specification of suggested resolution and confidence in the suggested resolution.
6. The proposed interface definition is provided for human review and validation.
7. Exemplar message is run through the validated interface definition to validate the interface definition.
8. The process is iterative. Test messages that are not validated by item 7 above (i.e., contain “bad data”) are resubmitted for examination by DALE for further modifications or adjustments to the interface definition (see items 3 and 4 above).
9. The feedback is used to enhance DALE.

DALE's task is to learn how an incoming data stream differs from the standard (i.e., learn what the errors are), and develop an interface definition that is sufficiently robust, depending on the context and user/customer needs, to start operation of the ILR system for that user/customer (e.g., creating and storing DMs, and other operations as described above). Key components of DALE and the machine-learning process are typically incorporated into the Cognitive AI Service 310 for use during operations, as discussed above.

Virtually any kind of content can be handled by the ILR system, including, but not limited to, image, text, free text, documents, media, external references, and the like. The present invention effectively separates the content from the data storage technology, so the content is readily importable and exportable. Supplemental content may be delivered associated with the CBR View Data Manager, including links to web sites or text describing instructions or other information. Content delivered to a user/customer/requestor is personalized, based on the user/customer/requestor and the context. ILR system parameter configurations, including site-specific versions, may also be stored.

System data backup is robust, with complete point-in-time recovery (PITR). The ILR databases include dynamic data, and backup is full and incremental, including write-ahead log (WAL) files (the system thus can recover from a catastrophic event). Static data (e.g., program files) backup is resourced from Source Control Management (SCM). Data backup is automated, and performed according to a recommended schedule, and configured to adapt to customer/user preferences. Backups can be saved to a customer-provided location. Disaster recovery option include hot standby, cold standby, and off-site replication.

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objects, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for managing entity life information; comprising:
one or more processors or microprocessors in electronic communication with at least one database on a memory storage device, wherein the one or more processors or microprocessors are programmed to:
receive, over a telecommunications network, data input messages containing entity care information from one or more data sources, wherein at least a portion of the data input messages are in different types and/or formats;
convert a data input message into a payload manifest schema comprising one or more observables, said observables comprising discrete data key-value pairs matching parsed data from the data input message to semantic ontology definitions;
transform the payload manifest schema to a curated manifest, said curated manifest comprising a multi-JSON semantic normalized representation of select entity care data; and
send the curated manifest for storage in said at least one database.

2. The system of claim 1, wherein the curated manifest is immutable.

3. The system of claim 1, wherein there is a single curated manifest created from a single data input message.

4. The system of claim 1, wherein the curated manifest has a structure comprising a header section, an actor section, an item section, and an observation section,

5. The system of claim 4, wherein the one or more processors or microprocessors are programmed to create an observation component for each observable data key-value pair, create an observation by grouping one or more observation components, and add the observation to the observation section of the manifest.

6. The system of claim 5, wherein the one or more processors or microprocessors are programmed to identify one or more actors in actor-related observations, perform an identity matching process to identity an entity corresponding to said one or more actors, and enter actor and entity data in the actor section of the curated manifest.

7. The system of claim 5, wherein the one or more processors or microprocessors are programmed to identify one or more items in item-related observations, and enter item data in the item section of the curated manifest.

8. The system of claim 1, wherein the one or more processors or microprocessors are programmed to receive, over a telecommunications network, a data request, and to provide a contextually best record view from the best data in one or more curated manifests responsive to the data request, wherein the best data is determined from contextual criteria based on the requested context.

9. The system of claim 8, wherein contextual criteria comprises data source.

10. The system of claim 8, wherein contextual criteria comprises data status.

11. The system of claim 8, wherein the contextually best record view is created on demand.

12. The system of claim 8, wherein the contextually best record view is a previously-created persisted contextually best record view.

13. The system of claim 12, wherein the persisted contextually best record view is updated in real-time as curated manifests are created.

14. The system of claim 1, wherein the receive function, convert function, and transform function are carried out with multiple process threads, wherein each thread corresponds to a specific function, and multiple functions can run simultaneously.

15. A method for managing entity life information; comprising:
one or more processors or microprocessors in electronic communication with at least one database on a memory storage device, wherein the one or more processors or microprocessors are programmed to:
receiving, by one or more processors or microprocessors in electronic communication with at least one database on a memory storage device, over a telecommunications network, one or more data input messages containing entity care information from one or more data sources, wherein at least a portion of the data input messages are in different types and/or formats;
converting a selected data input message into a payload manifest schema comprising one or more observables, said observables comprising discrete data key-value pairs matching parsed data from the data input message to semantic ontology definitions;
transforming the payload manifest schema to a curated manifest, said curated manifest comprising a multi-JSON semantic normalized representation of select entity care data; and
sending the curated manifest for storage in said at least one database.

16. The method of claim 15, wherein the curated manifest is immutable, and there is a single curated manifest created from a single data input message.

17. The method of claim 15, wherein the curated manifest has a structure comprising a header section, an actor section, an item section, and an observation section, and further comprising the steps of:
creating an observation component for each observable data key-value pair, create an observation by grouping one or more observation components;
adding the observation to the observation section of the manifest;
identifying one or more actors in actor-related observations;
performing an identity matching process to identity an entity corresponding to said one or more actors;
entering actor and entity data in the actor section of the curated manifest;
identifying one or more items in item-related observations, and
entering item data in the item section of the curated manifest.

18. The method of claim 15, further comprising the steps of:
receiving, over a telecommunications network, a data request; and
providing a contextually best record view from the best data in one or more curated manifests responsive to the data request;
wherein the best data is determined from contextual criteria based on the requested context, said contextual criteria comprising data source and/or data status.

19. The method of claim 15, wherein the contextually best record view is a previously-created persisted contextually best record view updated in real-time as curated manifests are created.

20. The method of claim 15, wherein the process steps of receiving, converting, and transforming are carried out with multiple process threads, wherein each thread corresponds to a specific process, and multiple processes can run simultaneously.
